(19) United States
(12) Patent Application Publication
(10) Pub. No.: US 2012/0183279 A1
(43) Pub. Date: Jul. 19, 2012

(54) ELECTRONIC DEVICE AND METHOD FOR RECORDING TV PROGRAMS

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/237,928

(22) Filed: Sep. 20, 2011

(30) Foreign Application Priority Data
Jan. 18, 2011 (TW) 100101736

(51) Int. Cl. H04N 5/76

(52) U.S. Cl. 386/291; 386/E05.001

(57) ABSTRACT

An electronic device for recording a TV program includes a parameter setting module, a recording module, a storing module, and a transmitting module. The parameters setting module receives parameters, and the parameters includes a TV channel, a segment condition, a start recording time and an end recording time of the TV channel. The recording module records the TV program of the TV channel to a first segment file from the start recording time to the end recording time. The storing module stores the first segment file when the segment condition is reached, and records the TV program to a second segment file after storing the first segment file. The transmitting module transmits the first segment file to a central server. The disclosure further offers a method for recording a TV program in the electronic device.

### BACKGROUND

1. Technical Field

The present disclosure generally relates to an electronic device, particularly to a method for recording a television program.

2. Description of Related Art

A user cannot comfortably watch two television (TV) programs simultaneously. A recording device can be used to record the TV programs when the user is absent or watching another program. The user can then watch the recorded TV programs at a later time. Typically however, the TV programs need to be recorded at the predefined time. Therefore, it is inconvenient for the user to record TV programs.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a system for recording a TV program.

FIG. 2 is a block view of the system of FIG. 1 according to one embodiment.

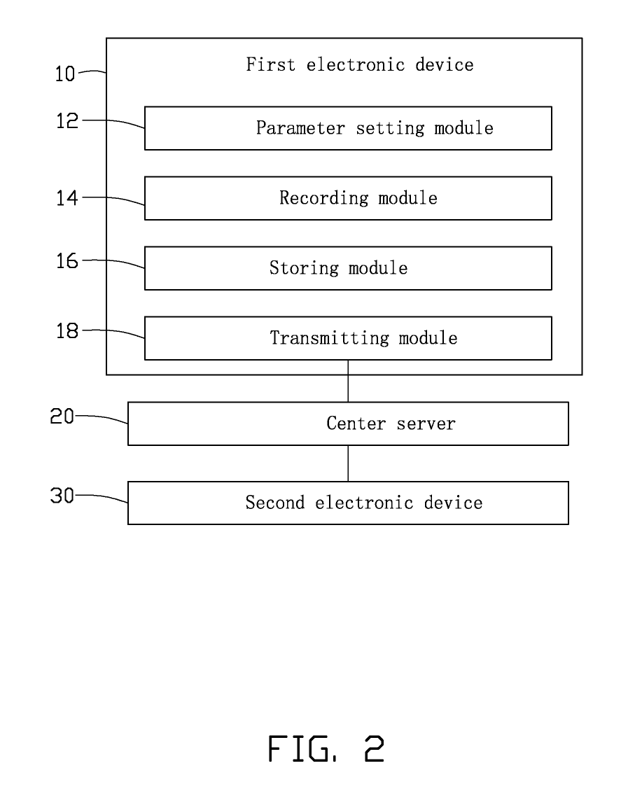

FIG. 3 is a schematic diagram of one embodiment of the function sub-modules of the system of FIG. 2.

FIG. 4 is an operational flow diagram representing one embodiment of a method for recording and sharing the TV program in a first electronic device.

FIG. 5 is an operational flow diagram representing one embodiment of a method for a recording module which records the TV program in the first electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

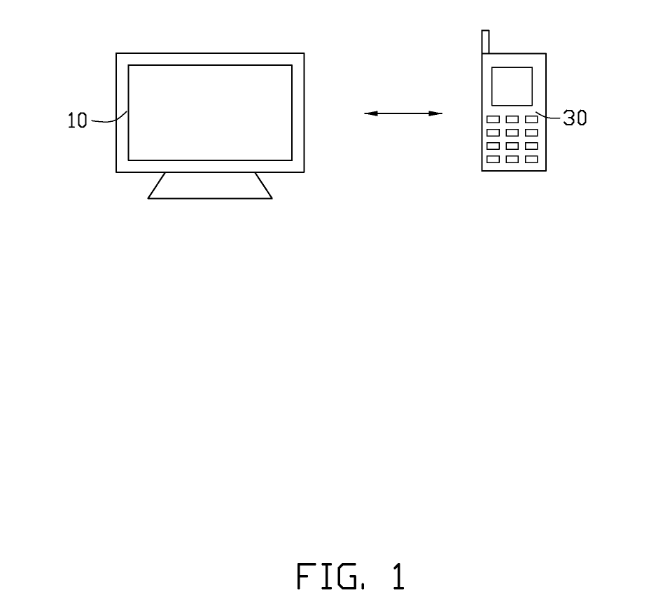

Referring to FIG. 1, one embodiment of a system for recording a TV program includes a first electronic device 10 and a second electronic device 30. The first electronic device 10 may be a TV capable of playing TV programs. TV programs are broadcasted during their regular scheduled programming. The scheduled programming can be obtained from various sources such as the internet or a newspaper. Recorded programs can be played on the second electronic device 30, which can be a desktop computer, a laptop computer, a tablet PC, or a smart phone. In one embodiment, the second electronic device 30 is connected to and controlled by the first electronic device 10 through a network based on a Transmission Control Protocol.

Referring to FIG. 1, the first electronic device 10 includes a parameter setting module 12, a recording module 14, a storing module 16, a transmitting module 18, and a center server 20. The storing module 16 is connected to the transmitting module 18 and the recording module 14 via a network, such as a User Datagram Protocol. The parameter setting module 12 may receive parameters set by a user. The parameter may include a TV channel to be recorded, a start recording time and an end recording time, a segment condition of the TV channel, a storing name of a segment file of the TV program, and storing paths of the recorded TV channel.

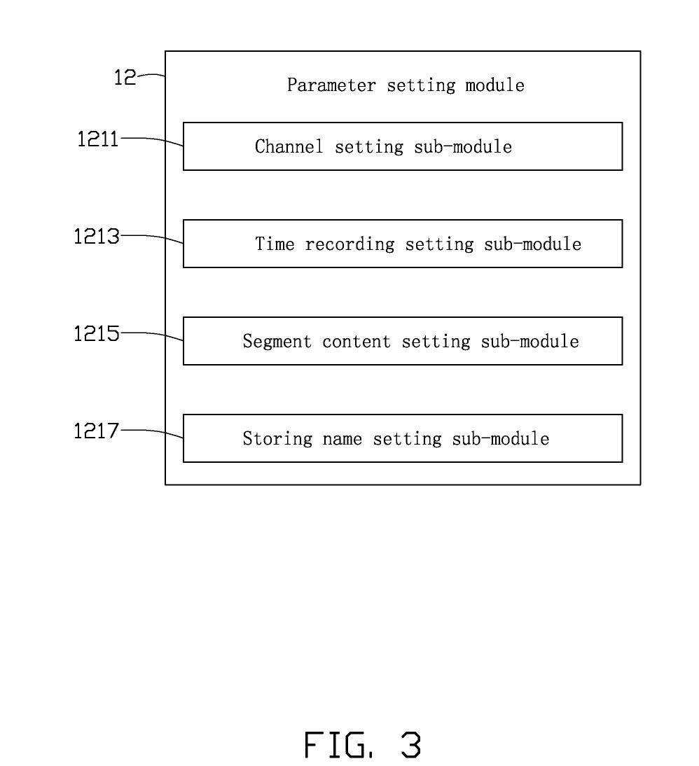

Referring to FIG. 3, one embodiment of the parameter setting module 12 includes a channel setting sub-module 1211, a time recording setting sub-module 1213, a segment condition setting sub-module 1215, and a storing name setting sub-module 1217. The channel setting sub-module 1211 provides a list of the TV channels for users. The time recording setting sub-module 1213 sets the start recording time and the end recording time. The segment condition setting sub-module 1215 sets the segment condition. The segment condition can include a time period and a file size value. In one embodiment, the time period may be 10 minutes or 15 minutes, and the file size value may be 5 megabytes or 10 megabytes. The storing name setting module 17 sets the name of the segment files, such as, 001, a1, and b1 for example. When the storing name is set, the segment files could be displayed in turn with 001, 002, 003 . . . , or a1, a2, a3 . . . , or b1, b2, b3 . . . . In one embodiment, the parameter setting module 12 can set a permission of the second electronic device 30, and only a second electronic device 30 having permission can access the center server 20.

The recording module 14 can check the network between the storing module 16, the transmitting module 18, and the recording module 14, record a TV program according to the parameters set by the parameter setting module 12, and transmit the recorded TV program to the storing module 14. When starting to record the TV program, the recording module 14 can search the TV program parameters. The recording module 14 starts to record the TV program, when a current time of the first electronic device is equal to the start recording time of the parameters. The recording module 14 stops to record the TV program when the current time is equal to the end recording time of the parameters. When recording the TV program, the recording module 14 can record the TV program according to the segment condition of the parameters. For example, if a segment condition is 15 minutes, the TV program is recorded for 15 minutes, and stored in the storing module 14 named 001 (a1). The next TV program then starts to record for 15 minutes, and stored in the storing module 14 named 002 (a2). When the last TV program is less than 15 minutes, but equal to the end recording time (T), the recording module 14 also stops recording, and transmits the last TV program to the storing module 14. All the segment files can be stored in the storing module 14 named 001, 002, 003 . . . , or a1, a2, a3 . . . .

The storing module 16 stores the parameters and the segment files. In one embodiment, the segment files are listed in turn. The transmitting module 18 can catch the segment files and transmit the segment files to the center server20 in turn. Therefore, users of the second electronic device 30 can enter the center server20 and watch or download the recorded TV program.

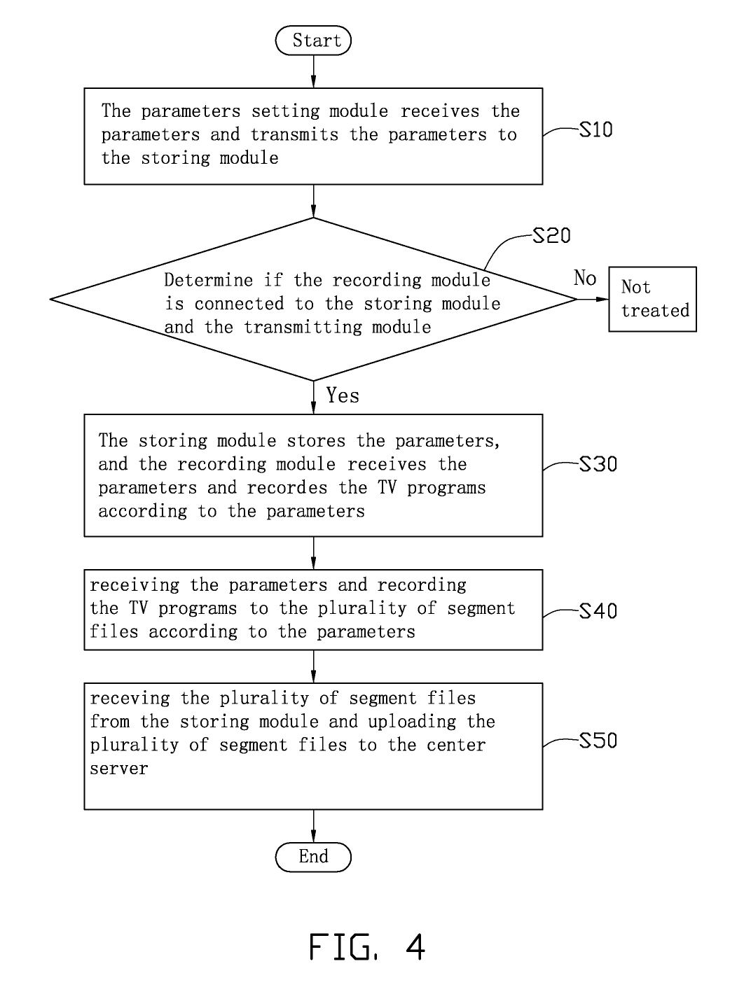

FIG. 4 is a flowchart illustrating one embodiment of a method for recording a TV program. The method may include the following steps.

In step S10, the parameters setting module 12 receives the parameters and transmits the parameters to the storing module 16. In one embodiment, the operating flow parameters may be programmed through a user interface displayed in the first electronic device 10. For example, if there is a football match on CCTV-5 from 19:00 to 20:10, the segment condition is the time period of 15 minutes, and the segment files are named at a1, a2, a3 . . . .

In step S20, the recording module checks if the recording module 14 is connected to the storing module 16 and the transmitting module 18. If the recording module is connected to the storing module 16 and the transmitting module 18, the method continues to step S30, and if not, otherwise, the method ends.

In step S30, the storing module 16 stores the parameters. The recording module 16 obtains the parameters and records the TV program to a plurality of segment files according to the parameters. When a first segment file of the plurality of segment files is recorded, the recording module 14 transmits the segment to the storing module 16 and begins to record a second segment file. When the plurality of segment files are all recorded, the plurality of segment files are transmitted to the storing module 16 and listed in turn.

In step S40, the storing module 16 receives and stores the first segment file with a name such as a1, and waits to receive and store the second segment file. The first segment file named a1, the second segment file is named a2, the third segment file is named a3, and the last segment file is named a(n).

In step S50, when the first segment file a1 is stored in the storing module 16, the transmitting module 18 obtains the first segment file a1 from the storing module 16 and uploads the first segment file a1 to the center server20, and waits for the transmission of the second segment file a2, until the last segment file a(n) is transmitted to the center server 20. When users watch or download the plurality of segmented files of the TV program, the users can access the center server 20. In one embodiment, only the user of the second electronic device 10 having permission can access the center server20 to watch or download the plurality of segmented files.

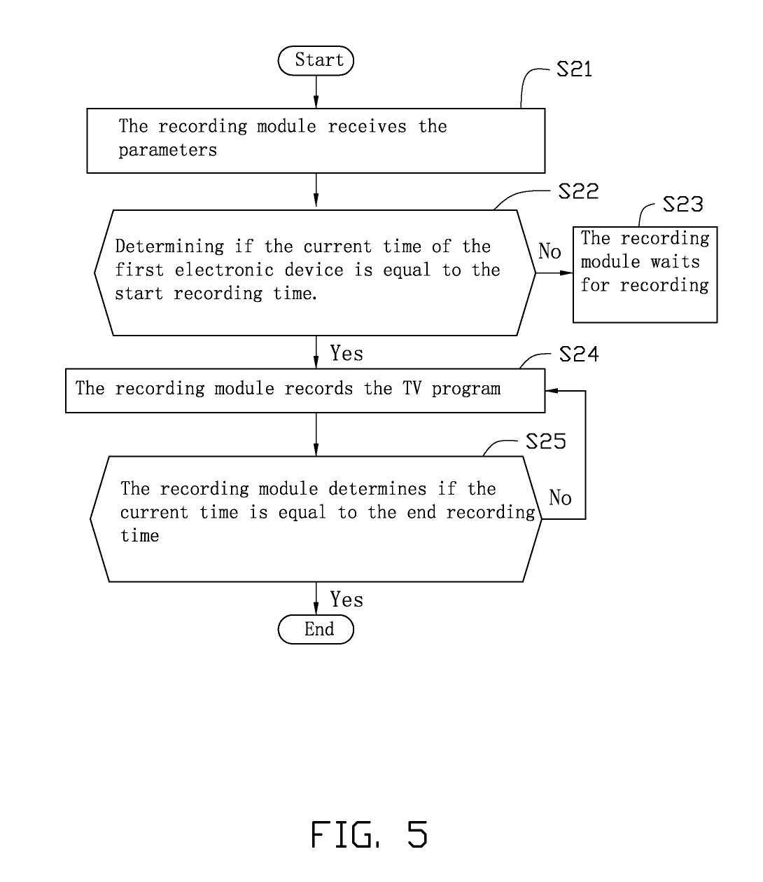

FIG. 5 is a flowchart illustrating one embodiment of a method for a recording module 14 recording a TV program. The method may include the following steps.

In step S21, the recording module 14 receives the parameters.

In step S22, when the recording module 14 has received the TV channel, the recording module 14 determines if the current time of the first electronic device 10 is equal to the start recording time. When the current time of the first electronic device 10 is equal to the start recording time, the method continues to step S24, otherwise, the method continues to step S23.

In step S23, when the current time is earlier than the start recording time, the recording module 14 waits to record.

In step S24, when the current time reaches the start recording time, the recording module 14 starts to record a first segment file of the TV program. After the first segment file has been recorded, the recording module 14 stores the first segment file to the storing module 16 named, for example, a1, and continues to record a second segment file.

In step S25, the recording module 14 determines if the current time reaches the end recording time. If the current time is equal to the end recording time, the method ends. If the current time is earlier than the end recording time, the method returns to step S24. Therefore, for the football game example, the plurality of segments files of the TV program are listed in the storing module 16 named a1, a2, a3, a4, a5. In one embodiment, the segment condition is the time period of 15 minutes, and because the last segment file a5 is 10 minutes and the current time is equal to the end recording time 20:10, the recording module 16 stops recording the last segment file a5. Therefore, each of the segment files a1, a2, a3, a4 is 15 minutes, but the last segment file a5 is 10 minutes.

In another embodiment, when at least two TV programs are to be recorded, the at least two TV programs are separately recorded and named with different names in the storing module 16.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A method for recording a TV program in an electronic device, the method comprising:
receiving parameters, wherein the parameters comprises a TV channel, a segment condition, a start recording time, and an end recording time of the TV channel;
recording the TV program of the TV channel to a first segment file from the start recording time;
storing the first segment file when the segment condition is satisfied;
recording the TV program to a second segment file after storing the first segment file; and
stopping recording the TV program of the TV channel when reach the end recording time.

2. The method of claim 1, wherein the segment condition comprises a time period, and the storing the first segment file when the segment condition reached comprises storing the first segment file when the time period expires timed from the start time.

3. The method of claim 1, wherein the segment condition comprises a file size value, and the storing the first segment file when the segment condition is satisfied comprises storing the first segment file when the file size of the first segment file reaches the file size value.

4. The method of claim 1, wherein the parameters further comprises a storing name, and the first segment file is named to the storing name when the first segment file is stored.

5. The method of claim 1, wherein the recording the TV program comprises continuing recording the segment file when a current time of the electronic device is less than the end recording time, and stopping recording the segment file when the current time is equal to the end recording time.

6. The method of claim 1, further comprising stopping recording the second segment file and storing the second segment file when the current time is equal to the end recording time.

7. The method of claim 1, wherein the electronic device is a television.

8. An electronic device for recording a TV program, comprising:
a parameter setting module receiving parameters, the parameters comprising a TV channel, a segment condition, a start recording time, and an end recording time of the TV channel;
a recording module recording the TV program of the TV channel to a first segment file from the start recording time to the end recording time;
a storing module storing the first segment file when the segment condition is reached, and recording the TV program to a second segment file after storing the first segment file; and
a transmitting module transmitting the first segment file to a central server.

9. The electronic device of claim 8, wherein the segment condition comprises a time period, and the storing module stores the first segment file when the time period expiries.

10. The electronic device of claim 8, wherein the segment condition comprises a file size value, and the storing module stores the first segment file when the file size of the first segment file reaches the file size value.

11. The electronic device of claim 8, wherein the parameters further comprises a storing name, and the first segment file is stored by the storing name.

12. The electronic device of claim 8, wherein the recording module continues recording the segment file when a current time is less than the end recording time, and the recording module stops recording the segment file when the current time is equal to the end recording time.

13. The electronic device of claim 8, wherein the recording module stops recording the second segment file when the current time is equal to the end recording time, and the storing module stores the second segment file.

14. The electronic device of claim 8, wherein the electronic device is a television.
